SEQUENCE LISTING (2 sequences)

SEQ ID NO: 1 - DNA, 23 bp, Beauveria sp
gcyccygghcaycgtgayttyat

SEQ ID NO: 2 - DNA, 23 bp, Beauveria sp
atgacaccracrgcracrgtytg

(19) United States
(12) Patent Application Publication
(10) Pub. No.: US 2020/0305439 A1
(43) Pub. Date: Oct. 1, 2020

(54) NOVEL STRAIN OF BEAUVERIA BASSIANA, CAPABLE OF INFECTING HORNETS

(71) Applicant: INSTITUT NATIONAL DE RECHERCHE POUR L'AGRICULTURE L'ALIMENTATION ET L'ENVIRONNEMENT, Paris (FR)

(72) Inventors: Juliette POIDATZ, Dreux (FR); Denis THIERY, Sadirac (FR); Bénédicte LABORIE, Chasselay (FR)

(21) Appl. No.: 16/955,995

(22) PCT Filed: Dec. 21, 2018
(86) PCT No.: PCT/EP2018/086488

§ 371 Date: Jun. 19, 2020

(30) Foreign Application Priority Data
Dec. 22, 2017 (EP) 17210041.4

(51) Int. Cl. A01N 63/30; C12R 1/645

(52) U.S. Cl. CPC A01N 63/30; C12R 1/645

(57) ABSTRACT

The present invention relates to a novel strain of the entomopathogenic fungus Beauveria bassiana, which presents the specificity of being able to infect the Asian hornet, Vespa velutina.

The present invention relates to a novel strain of the entomopathogenic fungus Beauveria bassiana, which presents the specificity of being able to infect hornets, more specifically the Asian hornet, Vespa velutina.

### BACKGROUND

Vespa velutina var. nigrithorax (Lepelletier, 1835) (Hymenopteran: Vespidae) is an invasive predator of arthropods, native from East Asia, that was accidentally introduced in France around 2004. Since then, this invasive wasp, also known as the Asian Predatory Wasp, the Asian hornet or the Yellow Legged hornet, is progressively spreading across Europe: in France, Spain, Portugal, Italy, Germany, Belgium (Monceau et al., 2014, Journal of Pest Science 87, 1-16), more recently in England and in Scotland (Keeling et al., 2017, Scientific Reports: 6240).

The main problem with this invasive species is that it is a very efficient predator of pollinators, especially of honeybees, and its fast territorial progression creates an additional biological pressure on beehives and the beekeeping economy. V. velutina has an annual development cycle: a foundress initiates the nest in spring, the colony grows until the end of autumn when the new sexed individuals (males and gynes) are produced. The colonies reach easily 4 000 individuals at this stage, and an estimation is that the global population produced annually by a nest can reach 15 000 individuals. Their nest is paper-made, closed, with one unique entering hole on its side. The nests are principally located in open spaces (trees, bushes, under frames), and in rare situations in closed places like roofs or holes.

Since this has become a major problem for the beekeeping industry, means to try controlling this species are being sought. The destruction of nests implies both material and qualified people. Moreover, nests are also often difficult to detect early in season and their destruction is most of the time rather dangerous and expensive. The methods that are currently used to limit the impact of V. velutina are i) trapping (essentially nutrition-baits), in spring for foundresses, and in summer-autumn for hunters, ii) physically protecting the apiaries by using nets or grids, and iii) nest destruction, using chemical insecticides (powders or liquids) or Sulphur dioxide (gas).

However, whatever the technique of nest control used, locating the nests early in season, i.e. before predation on beehives, remains the major unsolved limit, the colonies being discrete, numerous, often inaccessible and well-hidden mostly in the trees foliage.

A selective trapping system may be the solution, provided it is selective enough not to affect non-target organisms, its selectivity possibly being provided either by the bait (food type) or by the controlling insecticidal agent.

Biological control is a well-known method where certain organisms control pests by predation, pathogenicity or parasitism. V. velutina is parasitized by the tachinid fly Xenos Moutoni (Dipteran) in Korea; in France, the endoparasitdïd Conops vesicularis (Conopidae), and the nematode Pheromermis vesparum were found parasitizing V. velutina. Some viruses have also been observed to affect V. velutina. No application in biological control have however been yet envisaged with these species on V. velutina, because of low efficiency, limited risk assessment on non-target species and dispersion capacities or unadapted development cycles.

Entomopathogenic fungi are already being used as biological control agents against a certain number of crop pests. One interest is that almost all orders of the Insecta class are susceptible to be affected by some entomopathogenic fungi. One important property attributed to the use of entomopathogenic fungi is their relative specificity for a given host.

Beauveria bassiana is a well-known family of entomopathogenic fungi that is being used as a biological control solution in crop fields. B. bassiana strains are fungi that naturally grow in the soils almost anywhere in the world, infecting many insect species, and causing a disease named the white muscardine disease because of the white mold developing on the infected insects. One strain of B. bassiana, the strain 147, is commercialized under the brand name Ostrinil® as a solution for the biological control of the European Corn Borer, Ostrinia nubilalis, in maize fields, and for the control of the Palm Borer, Paysandria archon (EP2096926).

Although B. bassiana as a species is known to infect many insects, it is in fact well documented that specific strains of B. bassiana actually infect specific insect orders or even species. This relative host specificity of the B. bassiana strains has contributed a lot in making this fungus a suitable biological control agent that usually leaves non-target species unaffected while infecting their target hosts.

The inventors of the present invention have identified a strain of B. bassiana that is capable of infecting the Asian hornet, Vespa velutina.

### DESCRIPTION OF THE INVENTION

The present invention provides the strain of B. bassiana CNCM I-5254. The strain of B. bassiana CNCM I-5254 has the capacity to infect hornet species of the genus Vespa sp. The invention also includes any mutant of the strain of B. bassiana CNCM I-5254 that also has the capacity to infect hornet species of the genus Vespa sp.

According to a preferred embodiment, the hornet species of the genus Vespa sp. is the Asian hornet, V. velutina, more specifically the subspecies V. velutina nigrithorax.

The term “mutant” refers to a genetic variant derived from B. bassiana CNCM I-5254. In one embodiment, the mutant has one or more or all of the identifying (functional) characteristics of the B. bassiana CNCM I-5254 strain. In a particular instance, the mutant or a fermentation product thereof has the capacity (as an identifying functional characteristic) to infect hornet species of the genus Vespa sp., more particularly the Asian hornet, V. velutina, and more specifically the subspecies V. velutina nigrithorax, at least as well as the parent B. bassiana CNCM I-5254 strain. Such mutants may be genetic variants having a genomic sequence that has greater than about 85%, greater than about 90%, greater than about 95%, greater than about 98%, or greater than about 99% sequence identity to the B. bassiana CNCM I-5254 strain. Mutants may be obtained by treating a B. bassiana CNCM I-5254 strain cells with chemicals or irradiation, by selecting spontaneous mutants from a population of cells, by genome shuffling or cell fusion, and/or by other means well known to those practicing in the art.

Suitable chemicals for mutagenesis of the B. bassiana CNCM I-5254 strain include hydroxylamine hydrochloride, methyl methanesulfonate (MMS), ethyl methanesulfonate (EMS), 4-nitroquinoline 1 -oxide (NQO), mitomycin C or N-methyl-N′-nitro-N-nitrosoguanidine (NTG), to mention only a few (cf., for example, Stonesifer & Baltz, Proc. Natl. Acad. Sci. USA Vol. 82, pp. 1180-1183, February 1985). The mutagenesis of the B. bassiana CNCM I-5254 strain by, for example, NTG, using spore solutions of the respective B. bassiana CNCM I-5254 strain is well known to the person skilled in the art. See, for example Steven Harris, 2001, in Molecular and Cellular Biology of Filamentous Fungi, Ed. Nick Talbot, Oxford University Press: 47-58. Mutagenesis of spores of the B. bassiana CNCM I-5254 strain by ultraviolet light (UV) can be carried out using standard protocols. For example, conidia of the B. bassiana CNCM I-5254 strain can be plated and exposed to UV light.

The mutant strain can be any mutant strain that has one or more or all the identifying characteristics of B. bassiana CNCM I-5254 strain and in particular a capacity to infect hornet species of the genus Vespa sp., more particularly the Asian hornet, V. velutina, and more specifically the subspecies V. velutina nigrithorax that is comparable to or better than that of the respective B. bassiana CNCM I-5254 strain.

The “capacity to infect hornet” with regard to the strain of B. bassiana CNCM I-5254 or its mutants is the capacity for the entomopathogenic fungus to invade, grow, multiply and/or develop on and/or in the body of individual hornets in such a way that leads to the death of the hornets. Infection of hornets can, for example, be made according to any of the methods described in Example 2 herein, i.e. the direct contamination, the contamination by contact, the contamination by food ingestion, or the contamination from other hornets. The capacity to infect hornets can then be determined by measuring the death of infected hornets, preferably of a statistically-representative number of hornets, and comparing it to control non-infected hornets. Preferably, the death of the hornets occurs, on average (i.e. the death of 50% of a statistically-representative number of hornets), within 10 days after having been into contact with the entomopathogenic fungus, preferably within 9 days, within 8 days, within 7 days, within 6 days, and most preferably within 5 days.

The present invention also relates to a composition comprising the Beauveria bassiana CNCM I-5254 strain or a mutant thereof, or fermentation products of the Beauveria bassiana CNCM I-5254 strain or a mutant thereof that have adverse effects against hornets. An “adverse effect” is an impairment of at least one of the biological functions of the hornets thereby leading to their death or to their incapacity to perform their normal function in their colony.

Compositions of the present invention can be obtained by culturing the Beauveria bassiana CNCM I-5254 strain or mutants derived from it using conventional large-scale microbial fermentation processes, such as submerged fermentation, solid state fermentation or liquid surface culture, including the methods described, for example, in Burges, H. D., 1998. Formulation of mycoinsecticides. In H. S. Burges (Ed.), Dordrecht: Kluwer Academic, 131-185 ; in Lacey et al., 2015. Journal of Invertebrate Pathology 132, 1-41 ; or in Fernandes et al., 2015, Current Genetics, 19 May 2015. Fermentation is configured to obtain high levels of live biomass, including spores, and desirable secondary metabolites in the fermentation vessels.

A preferred form of the strain according to the invention is spores. Accordingly, a preferred composition according to the invention is a composition comprising spores of the strain Beauveria bassiana CNCM I-5254.

The fungal cells, spores and metabolites in culture broth resulting from fermentation (the “whole broth” or “fermentation broth”) may be used directly or concentrated by conventional industrial methods, such as centrifugation, filtration, and evaporation, or processed into dry powder and granules by spray drying, drum drying and freeze drying, for example.

The terms “whole broth” and “fermentation broth,” as used herein, refer to the culture broth resulting from fermentation before any downstream treatment. The whole broth encompasses the microorganism (e.g., B. bassiana CNCM I-5254 strain or a mutant strain thereof) and its component parts, unused raw substrates, and metabolites produced by the microorganism during fermentation. The term “broth concentrate,” as used herein, refers to whole broth (fermentation broth) that has been concentrated by conventional industrial methods, as described above, but remains in liquid form. The term “fermentation solid,” as used herein, refers to dried fermentation broth. The term “fermentation product,” as used herein, is a generic term referring to whole broth, broth concentrate and/or fermentation solids. Compositions of the present invention include fermentation products. In some embodiments, the concentrated fermentation broth is washed, for example, via a diafiltration process, to remove residual fermentation broth and metabolites.

In one embodiment, the fermentation broth contains at least about 1×10⁵ colony forming units (CFU) of the microorganism (e.g., Beauveria bassiana CNCM I-5254 strain or a mutant strain thereof)/mL broth. In another embodiment, the fermentation broth contains at least about 1×10⁶ colony forming units (CFU) of the microorganism (e.g., Beauveria bassiana CNCM I-5254 strain or a mutant strain thereof)/mL broth. In yet another embodiment, the fermentation broth contains at least about 1×10¹¹ colony forming units (CFU) of the microorganism (e.g., Beauveria bassiana CNCM I-5254 strain or a mutant strain thereof)/mL broth. In another embodiment, the fermentation broth contains at least about 1×10⁸ colony forming units (CFU) of the microorganism (e.g., Beauveria bassiana CNCM I-5254 strain or mutant strain thereof)/mL broth. In another embodiment, the fermentation broth contains at least about 1×10⁹ colony forming units (CFU) of the microorganism (e.g., Beauveria bassiana CNCM I-5254 strain or a mutant strain thereof)/mL broth. In another embodiment, the fermentation broth contains at least about 1×10¹⁰ colony forming units (CFU) of the microorganism (e.g., Beauveria bassiana CNCM I-5254 strain or a mutant strain thereof)/mL broth. In another embodiment, the fermentation broth contains at least about 1×10¹¹ colony forming units (CFU) of the microorganism (e.g., Beauveria bassiana CNCM I-5254 strain or a mutant strain thereof)/mL broth. One of skill in the art will understand that the concentrations described above relate to CFU measured shortly after completion of fermentation but that CFU levels will decline over time, depending on storage conditions. CFU levels of unformulated fermentation products of the microorganisms described herein are stable when the products are maintained in cold storage (e.g., about 4° C.) but decline at room temperature.

In one embodiment, the fermentation broth or broth concentrate can be formulated into liquid suspension, liquid concentrate, emulsion concentrate, or wettable powder with the addition of stabilization agents, preservatives, adjuvants, and/or colorants.

In another embodiment, the fermentation broth or broth concentrate can be dried with or without the addition of carriers, inerts, or additives using conventional drying processes or methods such as spray drying, freeze drying, tray drying, fluidized-bed drying, drum drying, or evaporation.

In some embodiments, the fermentation broth, broth concentrate or fermentation solid is treated in order to kill the microorganism, resulting in a fermentation product that consists of the killed microbe, its metabolites and residual fermentation media. Suitable treatments to accomplish this are known to those of skill in the art and include heat treatments.

In embodiments in which the fermentation broth or broth concentrate is freeze dried, one gallon of fermentation broth yields about 0.2 lb to about 1 lb freeze dried powder. In a particular instance, one gallon of fermentation broth yields about 0.4 lb to about 0.6 lb freeze dried powder. In another instance, one gallon of fermentation broth yields about 0.5 lb freeze dried powder.

In a further embodiment, the resulting dry products may be further processed, such as by milling or granulation, with or without the addition of inerts or additives to achieve specific particle sizes or physical formats or physical properties desirable for agricultural applications.

In addition to the use of whole broth or broth concentrate, cell-free preparations of fermentation broth of the novel variants and strains of the B. bassiana strain of the present invention can be obtained by any means known in the art, such as extraction, centrifugation and/or filtration of fermentation broth. Those of skill in the art will appreciate that so-called cell-free preparations may not be devoid of cells but rather are largely cell-free or essentially cell-free, depending on the technique used (e.g., speed of centrifugation) to remove the cells. The resulting cell-free preparation may be dried and/or formulated with components that aid in its application. Concentration methods and drying techniques described above for fermentation broth are also applicable to cell-free preparations.

In certain aspects, the fermentation product further comprises a formulation ingredient. The formulation ingredient may be a wetting agent, extender, solvent, spontaneity promoter, emulsifier, dispersant, frost protectant, thickener, and/or an adjuvant. In one embodiment, the formulation ingredient is a wetting agent. In other aspects, the fermentation product is a freeze-dried powder or a spray-dried powder.

Compositions of the present invention may include formulation ingredients added to compositions of the present invention to improve recovery, efficacy, or physical properties and/or to aid in processing, packaging and administration. Such formulation ingredients may be added individually or in combination.

The formulation ingredients may be added to compositions comprising cells, cell-free preparations and/or metabolites to improve efficacy, stability, and physical properties, usability and/or to facilitate processing, packaging and end-use application. Such formulation ingredients may include carriers, inerts, stabilization agents, preservatives, nutrients, or physical property modifying agents, which may be added individually or in combination. In some embodiments, the carriers may include liquid materials such as water, oil, and other organic or inorganic solvents and solid materials such as minerals, polymers, or polymer complexes derived biologically or by chemical synthesis. In some embodiments, the formulation ingredient is a binder, adjuvant, or adhesive that facilitates adherence of the composition to any relevant surface. The stabilization agents may include anti-caking agents, anti-oxidation agents, anti-settling agents, antifoaming agents, desiccants, protectants or preservatives. The nutrients may include carbon, nitrogen, and phosphorus sources such as sugars, polysaccharides, oil, proteins, amino acids, fatty acids and phosphates. The physical property modifiers may include bulking agents, wetting agents, thickeners, pH modifiers, rheology modifiers, dispersants, disintegrants, adjuvants, surfactants, film-formers, hydro tropes, builders, antifreeze agents or colorants. In some embodiments, the composition comprising cells, cell-free preparation and/or metabolites produced by fermentation can be used directly with or without water as the diluent without any other formulation preparation. In a particular embodiment, a wetting agent, or a dispersant, is added to a fermentation solid, such as a freeze-dried or spray-dried powder. A wetting agent increases the spreading and penetrating properties, or a dispersant increases the dispersibility and solubility of the active ingredient (once diluted) when it is applied to surfaces. Exemplary wetting agents are known to those of skill in the art and include sulfosuccinates and derivatives, such as MULTIWET™ MO-70R (Croda Inc., Edison, N.J.); siloxanes such as BREAK-THRU® (Evonik, Germany); nonionic compounds, such as ATLOX™ 4894 (Croda Inc., Edison, N.J.); alkyl polyglucosides, such as TERWET® 3001 (Huntsman International LLC, The Woodlands, Tex.); C12-C14 alcohol ethoxylate, such as TERGITOL® 15-S-15 (The Dow Chemical Company, Midland, Mich.); phosphate esters, such as RHODAFAC® BG-510 (Rhodia, Inc.); and alkyl ether carboxylates, such as EMULSOGEN™ LS (Clariant Corporation, North Carolina).

In some embodiments, the formulation inerts are added after concentrating fermentation broth and during and/or after drying.

The compositions according to the present invention can be used as such or, depending on their particular physical and/or chemical properties, in the form of their formulations or the use forms prepared therefrom, such as aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil- dispersible powders, oil-miscible flowable concentrates, oil-miscible liquids, foams, pastes, pesticide coated seed, suspension concentrates, suspoemulsion concentrates, soluble concentrates, suspensions, wettable powders, soluble powders, dusts and granules, water-soluble and water-dispersible granules or tablets, water-soluble and water-dispersible powders, wettable powders, natural products and synthetic substances impregnated with active ingredient, and also microencapsulations in polymeric substances and in coating materials, and also ULV cold-fogging and warm-fogging formulations.

In some embodiments, the composition is formulated as a water-dispersible granule or a wettable powder. In solid formulations, the composition of the present invention may contains at least about 1×10⁶ colony forming units (CFU), at least about 1×10⁷ CFU, at least about 1×10⁸ CFU, at least about 1×10⁹ CFU, at least about 1×10¹⁰ CFU, at least about 1×10¹¹ CFU, or at least about 1×10¹² CFU of the microorganism (e.g., Beauveria bassiana CNCM I-5254 strain or a mutant strain thereof)/gram.

The present invention also encompasses a method of producing a fermentation broth of Beauveria bassiana CNCM I-5254 strain or a mutant strain thereof. The method comprises cultivating the Beauveria bassiana CNCM I-5254 strain or a mutant strain thereof in a culture medium that contains a digestible carbon source and a digestible nitrogen source under aerobic conditions.

Any carbon source that is digestible (and thus available) for the Beauveria bassiana CNCM I-5254 strain or a mutant strain thereof can be used in the method of producing a fermentation broth (or fermentation method) as described here. Examples of suitable carbon sources include glucose, fructose, mannose, galactose, sucrose, maltose, lactose, molasses, starch (as an example for a polysaccharide), dextrin, maltodextrin (as an example of an oligosaccharide) or glycerin, to name only a few. The total initial concentration of the carbon source (or sources) may be any concentration that provides a suitable growth of the B. bassiana CNCM I-5254 strain or a mutant strain thereof and may be determined experimentally. The total initial carbon source concentration may, for example, be in the range of about 10 g/L to about 150 g/L, for example, about 10 g/L, about 20 g/L, about 30 g/L, about 40 g/L, about 50 g/L, about 60 g/L, about 70 g/L, about 80 g/L, about 90 g/L, about 100 g/L, about 110 g/L or about 120 g/L. In some embodiments, the carbon source might be a mixture of two or more carbon sources, for example, a mixture of glucose with a polysaccharide such as starch, a mixture of glucose and an oligosaccharide such as dextrin or maltodextrin or a mixture of glucose, starch and dextrin. In some embodiments the culture medium contains as carbon source a mixture of glucose and an oligosaccharide. The oligosaccharide may be maltodextrin or dextrin. In such embodiments, the initial maltodextrin concentration in the culture medium may be about 50 g/L to about 100 g/L or about 60 g/L to about 80 g/L. The initial glucose concentration in the culture medium may be about 20 g/L to about 80 g/L, for example, about 30 g/L, about 40 g/L, about 50 g/L, about 60 g/L or about 70 g/L. In other embodiments in which glucose is used as carbon source with maltodextrin or dextrin, the glucose concentration may be about 20 g/L to 60 g/L or about 30 g/L to about 50 g/L.

Any nitrogen source that is digestible can be used in the fermentation process described here. The nitrogen source can be a single source or a mixture of sources. In illustrative embodiments the nitrogen source is (at least partially) selected from the group consisting of soy peptone, soy acid hydrolysate, soy flour hydrolysate, casein hydrolysate, yeast extract, and mixtures thereof. The total initial concentration of the nitrogen source(s) may be any concentration that provides a suitable growth of the Beauveria bassiana CNCM I-5254 strain or a mutant strain thereof and production of the desired concentration of gougerotin and may be determined experimentally. Suitable total concentrations in the culture medium may, for example, be in the range of about 10 g/L to about 60 g/L, for example, about 20 g/L, about 30 g/L, about 40 g/L, about 50 g/L. In illustrative embodiments, the nitrogen source may be a mixture of casein hydrolysate and soy flour hydrate or a mixture of yeast extract and soy acid hydrolysate, wherein for example the yeast extract is used in the culture medium in a concentration (or amount) of 10 g/L and the soy acid hydrolysate is used in a concentration/amount of 20 g/L.

The culture medium can further contain a calcium source such as calcium chloride, or calcium carbonate. If present, the culture medium may contain a calcium source such as calcium carbonate in an initial concentration of about 1 g/L to 3 g/L.

In this context, it is noted that concentrations of all ingredients of the culture medium are given as concentration at the beginning of the fermentation (initial concentrations) unless indicated otherwise. The concentrations are based on the post inoculation volume that is used for the fermentation. The initial concentrations as given here can either be maintained during the fermentation by continuous nutrient feeding or, alternatively, the ingredients (carbon source, nitrogen source, amino acid) can be added only at the beginning of the fermentation. However, the pH of the culture medium/fermentation broth is typically continuously monitored and controlled by addition of a suitable acid (such as sulfuric acid or citric acid) and/or of a suitable base (such as sodium hydroxide or ammonia solution or potassium hydroxide). An appropriate pH can be determined empirically. In typical embodiments the pH of the culture medium/fermentation broth is in range of 6.5 to 7.5, for example, 6.8 to 7.0. Also process parameters such as temperature and aeration rate are usually controlled over the course of fermentation process. Since the cultivation of the Beauveria bassiana CNCM I-5254 strain or a mutant strain thereof is carried out under aerobic conditions, the fermentation broth is typically aerated with air, oxygen enriched air or if necessary, pure oxygen. The temperature is usually chosen to be within a range of 20° C. to 30° C., however higher temperatures are also contemplated herein. Standard fermentation reagents such as antifoam agents may also be added continuously. The production of the fermentation broth can be carried out using conventional large-scale microbial fermentation processes, such as submerged fermentation, solid state fermentation or liquid surface culture, including the methods described, for example, in Burges, H. D., 1998. Formulation of mycoinsecticides. In H. S. Burges (Ed.), Dordrecht: Kluwer Academic, 131-185 ; in Lacey et al., 2015. Journal of Invertebrate Pathology 132, 1-41; or in Fernandes et al., 2015, Current Genetics, 19 May 2015.

The strain or the compositions according to the invention are preferably used in a form that is suitable to be sprayed on and/or in the nests of hornets. A preferred form of the entomopathogenic strain of the invention is spores of the strain. Accordingly, the invention encompasses a composition according to the invention that is suitable to be sprayed on and/or into the nests of hornets.

The invention therefore also encompasses a method for treating the nests of hornets with the strain or the compositions according to the invention, comprising spraying the strain and/or compositions on and/or into the nests. The spray may be applied with any sprayer suitable for spraying on and/or into the nests of hornets, e.g. any sprayer comprising a lance and a nozzle adapted to the nests of hornets and/or their location in their natural habitat. Preferably, the method comprises spraying the strain and/or compositions into the nests. For example, the inventors of the present invention have identified that the treatment of hornet nests is more efficient if the spray is applied into the nest, i.e. by first perforating the nest and then introducing the spraying nozzle and the extremity of the spraying lance directly into the nest. Such applications may be performed directly by a person being brought close to the nest by any elevating means due to the fact that hornets nests are usually located high in trees. However, such method may put the person applying the treatment at risk of bites by hornets and therefore requires it to wear a complete protection equipment. Alternatively, this method of treatment may be performed by any suitable remotely-controlled flying device equipped with a sprayer and loaded with the strain or the compositions according to the invention. Accordingly, the person piloting the remotely-controlled flying device could stay at a safe distance from the nest. A convenient remotely-controlled flying device is a drone.

Alternatively, the invention also encompasses a method for treating the nests of hornets with the strain or the compositions according to the invention, comprising introducing the strain and/or compositions on and/or into the nests. A convenient means for introducing the strain and/or compositions on and/or into the nests is a shooting means capable of propelling a loadable projectile. Accordingly, the shooting means may be any type of gun or rifle, and the projectile may be a small ball that is loaded with the strain or the compositions according to the invention. The person performing such method therefore shoots the hornet nest from a distance that is reachable by the shooting means used, thereby introducing balls into the nest. The balls then release the strain or the compositions according to the invention directly into the nest. The shooting means may also be a blowgun or a slingshot propelling a ball loaded with the strain or the compositions according to the invention. It may also be a bow or a crossbow and the strain or the compositions according to the invention is then loaded at the extremity of an arrow. Such shooting means may either be directly actioned from the ground by a person, or they may be affixed to a remotely-controlled flying device and then actioned indirectly by the person piloting such device.

Further alternatively, the strain or the compositions according to the invention are used in a form that is suitable to be deposited, preferably a liquid form, either manually by man or automatically by any suitable device, on the body of individual hornets. According to such embodiment, the individual hornets are captured before the strain or the composition is deposited on their body. Alternatively, the individual hornets may be attracted in a place or a device where the strain or the composition is deposited on their body. Accordingly, the invention also encompasses a device comprising means that are suitable for depositing a certain amount of the strain or composition according to the invention on their body.

According to such embodiment, the invention also encompasses a method for contaminating a nest of hornets, characterized in that (i) at least one hornet is captured, (ii) a certain amount of the strain or the compositions according to the invention is deposited on its body, and (iii) the hornet is released and allowed to return to its nest. Alternatively, step (i) of the method may be replaced by a step of (i) at least one hornet is attracted in a place or a device. The principle underlying this method is that the strain or the composition according to the invention that is deposited on the captured hornet is not immediately infecting it, so that it can return to its nest, where it further contaminates the nest and other individual hornets present in the nest by contact. The strain then progressively infects the treated hornet and the other hornets with which it has been in contact, thereby progressively contaminating the other hornets of the nest. The consequence of such progressive contamination is that the whole hornet population of the nest becomes infected by the strain of the invention and eventually entirely, or at least largely, killed by the strain.

According to another embodiment, the invention encompasses a food composition that is attractive for hornets to feed on and which comprises either the strain or the compositions according to the invention or both. The food composition may comprise a proteinaceous component, such as for example any untransformed or transformed food based on seafood (fish or shellfish) or meat, and/or a carbohydrate-containing component, such as for example honey. According to such embodiment, the food composition is used as bait for the hornet.

According to this embodiment, the invention also encompasses a method for contaminating a nest of hornets, characterized in that a food composition attractive for hornets to feed on and comprising either the strain or the compositions according to the invention or both is provided in an area where hornets have been observed. The principle underlying this method is that, by feeding on the food composition, the hornets contaminate themselves with the strain or composition according to the invention by ingestion and, when returned to their nest, display a trophallaxis behavior consisting in regurgitating ingested food to share with other individual hornets of the nest or with their larvae.

### Deposit Information

A sample of the Beauveria bassiana strain of the invention (also identifiable as BB-Jubede-INRYER) has been deposited at the Collection Nationale de Cultures de Microorganismes (CNCM) of the Institut Pasteur, 25 rue du docteur Roux, 75724, Paris, France (an International Depository Authority under the Budapest Treaty), on Oct. 30, 2017, and has been assigned the following registration number: CNCM I-5254.

The various aspects of the invention will be understood more fully by means of the experimental examples below.

All the methods or operations described below are given by way of example and correspond to a choice, made among the various methods available for achieving the same result. This choice has no effect on the quality of the result, and, consequently, any appropriate method can be used by those skilled in the art to achieve the same result. In particular, and unless otherwise specified in the examples, all the recombinant DNA techniques employed are carried out according to the standard protocols described in Sambrook and Russel (2001, Molecular cloning: A laboratory manual, Third edition, Cold Spring Harbor Laboratory Press, NY) in Ausubel et al. (1994, Current Protocols in Molecular Biology, Current protocols, USA, Volumes 1 and 2), and in Brown (1998, Molecular Biology LabFax, Second edition, Academic Press, UK). Standard materials and methods for plant molecular biology are described in Croy R. D. D. (1993, Plant Molecular Biology LabFax, BIOS Scientific Publications Ltd (UK) and Blackwell Scientific Publications (UK)). Standard materials and methods for PCR (Polymerase Chain Reaction) are also described in Dieffenbach and Dveksler (1995, PCR Primer: A laboratory manual, Cold Spring Harbor Laboratory Press, NY) and in McPherson et al. (2000, PCR—Basics: From background to bench, First edition, Springer Verlag, Germany).

### EXAMPLES

### Example 1: Isolation and Culture of the Strain of Beauveria Bassiana CNCM I-5254

The strain of Beauveria bassiana CNCM I-5254 has been collected in the French region Bretagne (North West of France), and was found directly in a foundress of V. velutina in spring 2016. After a rapid cleaning of the external cuticle of the infected individual using a hypochlorite bath of 10 seconds, the hornet was cut in 3 parts that were each placed in different Petri dishes on growing media OAC (Oat 40 g, Agar (PDA, BK095HA, Biokar) 20 g, Chloramphenicol (SIGMA Aldrich, Germany) 50 mg, QS 1 L). All isolates were purified by multi-passaging, i.e. repeated subculture of the fungi in Petri dishes for at least 5 generations.

### Example 2: Characterization of the Strain of Beauveria Bassiana CNCM I-5254

### 2.1. Macroscopic Description

White mycelium
Colony shape: regular round
Colony aspect: white cottony compact
Colony edges: well-defined
Conidia color: colorless

### 2.2. Microscopic Observation

A fungus preparation colored by methylene blue was made on a microscopic lamella, then the fungus structure (x40) was observed to make a further diagnostic of the species. Under microscope, we found conidiophores as sympodulospores (conidia positioned in zig-zag) and small round spores, which are characteristic of the species B. bassiana.

### 2.3. Genetic Analysis

DNA extraction: after lyophilisation of mycelium samples, DNA was extracted using the technique described by Zolan, M. E. & Pukkila, P. J., 1986, Mol Cell Biol. 6 (1):195-200, without Proteinase K.

PCR: The DNA was concentrated at two different concentrations for running the PCR: 20 and 50 μL/ml. Because of the strong presumption, on the basis of the macro and microscopic observations, that the fungi would be a Beauveria sp., we chose the primers designed to amplify a portion of the Translation Elongation Factor 1α gene, TEF-exon 983F:

| | |
|---|---|
| 983F: | GCYCCYGGHCAYCGTGAYTTYAT |
| 2218R: | ATGACACCRACRGCRACRGTYTG |

We used 0.2 μL of primer 983F and 0.2 μL of 2218R, with 0.2 μL of dNTPs, 1.5pL of PCR Buffer 10×, 0.45 μL of MgCl2, 11.31 μL ultrapure (milli-Q®) water, 0.04 μL of Taq polymerase and 1.1 μL of DNA. A Touchdown PCR was performed, i.e. with a diminution of 1° C. in each 9 first cycles. The PCR products were validated by an electrophoresis migration (Agarose 2%).

DNA migration of the PCR products on agarose revealed strong signals for the 50 ng/μL DNA concentrated products, but too light signals at 20 ng/μL. Only the 50 ng/μL DNA concentrated products were therefore genotyped. After sequencing and sequence cleaning, the resulting sequences were aligned using the publicly-available MUSCLE software (Edgar et al., 2004, BMC Bioinformatics 5:113). The results of the MUSCLE alignments show that the fungus matches 100% with other B. bassiana strains.

### 2.4. Reinfection

In order to assess the capacity of reinfection of the isolated strain, 15 workers of V. velutina were inoculated with the fungus by immersion of 1 second in a 10⁷ spores/ml solution. It was observed that the symptoms could be reproduced on 10 of the 15 infected V. velutina workers, thereby further confirming the nature of the fungi.

### Example 3: Description of the Assays

### 3.1. Inoculation Methodology

Different inoculation methods were used for assessing the potential control efficiency of the B. bassiana strain: direct inoculation (P), contact with a contaminated surface (C), ingestion from contaminated food (N), and inter-individual transfer (T).

All the petri dishes roofs were pierced with a thin needle for aeration (15 holes) the day before the experiment. On the day of the experiment, the spore solutions were prepared under sterile conditions, and fixed at a concentration around 10⁷ spores/ml. The control was distilled water. The hornets were cooled for 20 minutes in conical centrifugation tubes (Falcon® type) that were put in ice, so they can be manageable during the fungus inoculation. The hornet workers were grouped after inoculation. After contamination, for the three first treatment methods, the hornets were put in groups of five in each Petri dishes of 10 cm diameter, that contained a thick filter paper on the ground, a cup with water in cotton, and a cup with food (candy sugar NutriBee® Propolis, Vétopharma). For the fourth treatment method, i.e. contamination by transfer, we chose bigger pots (plastic honey pots, 9 cm bottom diameter×10 cm top diameter×12 cm high) with a strip of embossed paper. After placing the hornets in the different arenas, they were left for 5 to 10 minutes at room temperature to recover from cold.

After inoculation, the boxes containing the hornets contaminated according to the different methods were all placed in a climatic chamber at 23° C.±1° C., 12 h/12 light.

Three repetitions of the bioassay were made, each with 10 individuals/method: in August 2016, in September 2016 and in October 2016.

### Direct Contamination Method

The hornets were contaminated by immersion (<1 sec) in a spore solution. The forceps used to manipulate the hornets for this method were first disinfected with ethanol (90%) then washed with water.

### Contamination by Contact Method

According to this method, 3 ml of spore solution was poured uniformly on the filter paper in the Petri dish. The paper was left air-drying for five minutes before putting the candy, the water and the hornets inside the box.

### Contaminated Food Method

According to this method, 1 ml of spore solution was poured on 10 mg of cooked tuna. The fish was left in the boxes only 24 h to avoid hornet intoxication by potential bacterial development.

### Inter-Hornets Contamination Method

Four hornets were placed in a pot as described above. One extra individual was directly contaminated according to the “direct contamination” method, then placed opposite to the other hornets in the box.

### 3.2. Parameters Measured

### Mortality Index

Each day post-inoculation, dead hornets were removed from the boxes and placed individually in labeled hemolysis tubes closed with a cotton plug. Humidity of the tubes was maintained by moisturizing the copper with distilled water.

In order to measure the death of hornets only due to the entomopathogenic fungi, the isolated dead individuals were observed each day for the fungus to emerge from the cuticle's intersections. The death of the hornets could be due to multiple factors (age, bacterial infection, stress, etc.), and death of hornets that could not be attributed to the entomopathogenic fungi were not counted as dead. Accordingly, in the calculation of the below Mortality Index (MI), the number of “alive individuals” in both the Control and the Treatment situations corresponds to the number of hornets that effectively survived the assays, plus the number of hornets that died during the assay for a reason not attributable to the entomopathogenic fungi.

$$Mortality Index = \frac{Control alive individual - Treatment alive individual}{Control alive individual}$$

### Aggressiveness

Aggressiveness is measured as the time after inoculation when 50% of the hornets died by infection.

### 3.3. Results

The table below reports the Mortality Index (Average MI of the 3 repetitions) for the different assays (n=number of hornets; SD=Standard Deviation; Last column: values with the same letter are not significantly different (p>0,05) after parametric LSD Fisher test (alpha=0.05; DMS=0.12264; Error: 0.0746; gl: 151)).

No death of hornets due to entomopathogenic fungi was observed in the control.

| Treatment | Average MI | n | SD | |
|---|---|---|---|---|
| Food | 0 | 38 | 0, 04 | A |
| Transfert | 0, 16 | 38 | 0, 04 | B |
| Contact | 0, 2 | 38 | 0, 04 | B |
| Direct | 0, 54 | 41 | 0, 04 | C |

The most efficient inoculation method concerning lethality was the direct inoculation, statistically more efficient than the contact, which was not different from the transfer method. The food treatment did not show any effect in the configuration of the assay. This latter result may be due to the nature of the food used, mostly proteinaceous, while some hornets may prefer to consume carbohydrate-based foods, possibly depending their age and role in the hornet's colony.

Aggressiveness of the strain of B. bassiana was 6 days.

1. A strain of the fungus Beauveria bassiana, wherein a sample of said strain has been deposited at the Collection Nationale de Cultures des Microorganismes (CNCM) under registration number CNCM I-5254, or a mutant thereof having the capacity to infect hornet species of the genus Vespa sp.

2. Spores of the strain according to claim 1.

3. A composition comprising a biologically-pure culture of the strain according to claim 1 or the spores according to claim 2.

4. A composition comprising fermentation products of the strain according to claim 1.

5. A method for treating the nests of hornets with the strain, its spores, or the composition according to any of claims 1 to 4, comprising spraying the strain, its spores, and/or the composition on and/or inside the nests with any suitable spraying means.

6. The method according to claim 5, characterized in that the strain or the composition is applied into the nests.

7. The method according to claim 6, characterized in that the method additionally comprises a preliminary step of perforating the nest with any means suitable for perforating the nests.

8. The method according to claim 7, characterized in that the means suitable for perforating the nests is the suitable spraying means.

9. A method for contaminating a nest of hornets, characterized in that (i) at least one hornet is captured, (ii) a certain amount of the strain, its spores, or the compositions according to any of claims 1 to 4 is deposited on its body, and (iii) the hornet is released and allowed to return to its nest.

10. A device comprising means that are suitable for depositing a certain amount of the strain, its spores, or composition according to any of claims 1 to 4 on the body of hornets.

11. A food composition that is attractive for hornets to feed on, characterized in that it comprises either the strain, its spores, or the compositions according to any of claims 1 to 4 or both.

12. A method for contaminating a nest of hornets, characterized in that a food composition according to claim 11 is provided in an area where hornets are observed.
